(19) United States
(12) Patent Application Publication
(10) Pub. No.: US 2008/0284789 A1
(43) Pub. Date: Nov. 20, 2008

(54) Image processing circuit

(75) Inventor: Atsushi Yabushita, Kanagawa (JP)

Correspondence Address: JUNICHI MIMURA;OKI AMERICA INC., 1101 14TH STREET, N.W., SUITE 555, WASHINGTON, DC, 20005, US

(73) Assignee: Oki Electric Industry Co., Ltd.

(21) Appl. No.: 12/073,969

(22) Filed: Mar. 12, 2008

(30) Foreign Application Priority Data
May 18, 2007 (JP) 2007-132596

(51) Int. Cl. G06T 1/60

(52) U.S. Cl. 345/559

(57) ABSTRACT

an image processing circuit includes a memory storing an image data, which includes a plurality of line data disposed regularly a first module performing a plurality of thinning processes, at each of which a plurality of line data are readout from the memory, and at each of which one line data is processed by using the readout line data, wherein the processed line data is restored in the memory, and wherein the first image processing module outputs a first signal after the thinning processes for a certain times are completed, and a second module, which start its operation in response to the first completion signal, performing a similar image-process performed by the first module, wherein the second image processing module outputs a second completion signal after the thinning processes for the entire image data stored in the memory are completed.

### CROSS-REFERENCE TO RELATED APPLICATION

This application claims the priority benefit of Japanese Patent Application No. 2007-132596, filed May 18, 2007, the entire disclosure of which is incorporated herein by reference.

### BACKGROUND OF THE INVENTION

1. Field of the Invention

The invention relates to an image processing circuit including a thinning process, specifically an image processing circuit having high speed arithmetic process ability.

2. Description of the Related Art

In order to extract characteristics of a fingerprint from its image data obtained by a scanner, a conventional image processing circuit disclosed in Japanese patent laid open publication No. 2000-020693A performs some image-processes, through which an image having a fine line along the fingerprint valley from the image data obtained by the scanner is generated. Generally, such a process is performed by an image processing circuit shown in FIG. 5, which shows its circuit diagram. The image processing circuit in the related art and the method of processing the image data in the image processing circuit are explained below with reference to FIG. 5, FIG. 6A and FIG. 6B. FIG. 6A shows a sample image data of a finger print, and FIG. 6B shows a conceptual diagram for processing the sample image data shown in FIG. 6B in the image processing circuit shown in FIG. 5.

As shown in FIG. 5, the image processing circuit 300 in the related art includes an image processing module 1 and a memory 2. The image processing module 1 includes an arithmetic unit 1a, which performs the thinning processes, a judgment unit 1b, which judges whether or not a predetermined image-process under which the predetermined conditions are satisfied by the several thinning processes, is completed, and an unillustrated controller, which controls the entire module 1.

As shown in FIG. 6A, image data 5 of a fingerprint obtained by the scanner are stored in the memory 2, initially. Then, the image data 5, which are defined in matrix, are readout line by line, by the arithmetic unit 1a of the image processing module 1(hereinafter the readout image data by a line is called the line data). The memory 2 is, then, used as a work area for re-storing the data whenever the thinning process is performed. Finally, the image data that the image-process is completed are stored in the memory 2.

Next, the operation of the image-process is explained below. Before performing the thinning processes, the image data 5 of the fingerprint obtained by the scanner are stored in the memory 2. The image data are represented by two-value data in which a fingerprint ridge is represented by a white pixel and a fingerprint valley is represented by a black pixel wherein the black pixel has a certain level of a width. Therefore, in order to extract characteristics of a fingerprint from its image data, some black pixels are changed to white pixels for generating a single serial thin curve-line, which is made up with the black pixels under the thinning process.

The arithmetic unit I a readouts the line data of a first through third lines from the memory 2 in response to an activation signal STA applied from the controller, and performs the thinning process to the line data in the middle, which is the second line data, from the three line data. The result of the thinning process is restored in the second line of the image data in the memory 2, that is, the second line data are renewed by the thinning process while other two line data, which are the first and the third line data, are not renewed.

Next, the arithmetic unit 1a readouts the line data of the second through the fourth lines from the memory 2. Then, as well, the arithmetic unit 1a performs the thinning process to the line data in the middle, which is the third line data, from the three line data. The result of the thinning process is re-stored in the third line of the image data in the memory 2, that is, the third line data are renewed by the thinning process while other two line data, which are the second and the fourth line data, are not renewed.

The thinning process is repeated to the line data, which is one line before the last line data, which is at the line 99 in the FIG. 6A of the image data, whereby a first image-process is completed. As a result of the first image-process, the second through-the ninety-ninth line data are renewed by each thinning process, except for the first and the hundredth line data.

In FIG. 6B, the image-process is repeated for (j) times (j=1, 2, . . . ) while the image data is defined in (i) lines (i=2˜99). In this example, the first line data through the (i−1)th line data, for which the thinning processes are performed for the (j) times and (i)th through 100^{th} line data, for which the thinning processes are performed for the (j−1) times, are stored in the memory 2. Then, the arithmetic unit 1a readouts the (i−1)th line data, the (i)th line data and (i+1) line data wherein the thinning processes are performed for the (j) times to the (i−1)th line data and the thinning processes are performed for the j times to the (i)th line data and (i+1) line data. The arithmetic unit 1a generates the (i)th line data from the three readout line data by performing the thinning process. The generated (i)th line data is restored at the (i)th line of the image data in the memory 2.

After the first image-process having the several thinning processes is completed, the judgment unit 1b judges whether or not the predetermined image-process under which the predetermined requirements are satisfied by the several thinning processes, is completed. As a result of the judgment made by the judgment unit 1b, a judgment signal RES is outputted. While the predetermined conditions are not satisfied by the several thinning processes, the image-process is repeated until the predetermined conditions are satisfied.

When the judgment signal RES showing that the predetermined conditions are satisfied is outputted, the operation of the image processing module 1 is terminated, and the image data that the thinning process is completed are stored in the memory 2.

However, in such an image process circuit 300, since the second image-process starts after the first image-process is terminated and the third image-process starts after the second image-process is terminated, namely, since the image-processes are performed sequentially, it takes a time to complete the image-processes.

### SUMMARY OF THE INVENTION

An objective of the invention is to solve the above-described problem and to provide an image processing circuit having high speed arithmetic process ability.

The objective is achieved by an image processing circuit including a memory storing an image data, which includes a plurality of line data disposed regularly, a first module performing a plurality of thinning processes, at each of which a plurality of line data are readout from the memory, and at each of which one line data is processed by using the readout line data, wherein the processed line data is restored in the memory, and wherein the first image processing module outputs a first signal after the thinning processes for a certain times are completed, and a second module, which start its operation in response to the first completion signal, performing a similar image-process performed by the first module, wherein the second image processing module outputs a second completion signal after the thinning processes for the entire image data stored in the memory are completed.

### BRIEF DESCRIPTION OF THE DRAWINGS

The invention will be more particularly described with reference to the accompanying drawings, in which:

FIG. 1 is a circuit diagram of an image processing circuit, according to a first embodiment;

FIG. 2 is a conceptual view for explaining an operation of image-processes, each having a plurality of thinning processes, in the image processing circuit of FIG. 1;

FIG. 3 is a conceptual view for explaining an operation of image-processes, each having a plurality of thinning processes, in an image processing circuit, according to a second embodiment;

FIG. 4 is a circuit diagram of an image processing circuit, according to a third embodiment;

FIG. 5 is a circuit diagram of an image processing circuit in the related art;

FIG. 6A is a sample image data of a finger print; and

FIG. 6B is a conceptual diagram for image-processing the sample data shown in FIG. 6B in the image processing circuit shown in FIG. 5.

### DETAILED DESCRIPTION OF THE PREFERRED EMBODIMENTS

The first through third embodiments of the invention as to an image processing circuit are explained together with drawings as follows. In each drawing, the same reference numbers designate the same or similar components through all embodiments.

### The First Embodiment

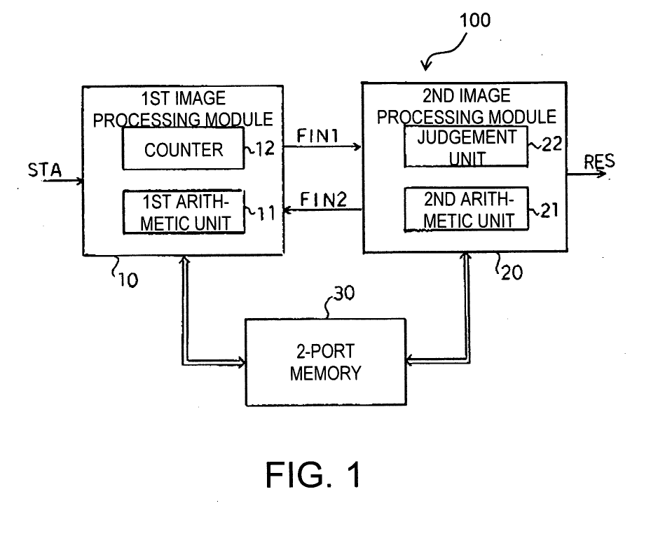

FIG. 1 is a circuit diagram of an image processing circuit 100, which performs image-processes, through which an image having a fine line along the fingerprint valley from image data obtained by a scanner is generated, according to a first embodiment. As shown in FIG. 1, the image processing circuit 100 includes a first image processing module 10, a second image processing module 20 and a 2-port memory 30. The first image processing module 10 includes a first arithmetic unit 11, a counter 12 and an unillustrated controller. The first arithmetic unit 11 performs thinning processes to the image data, which are readout from the 2-port memory 30. The counter 12 counts the number of times that the thinning processes to line data are performed. Namely, the line number of the line data to which the thinning process was performed, can be identified by the counter 12. The first image processing module 10 states its operation in response to an activation signal STA applied from the controller and outputs a first completion signal FIN1 to the second image processing module 20 when the thinning processes to the predetermined line data of the image data are completed. The thinning processes to the unprocessed line data are continued, and the operation of the first image processing module 10 is halted when the first image-process is completed. Then, the first image processing module 10 resume its operation for the second image-process upon receiving a second completion signal FIN2 outputted from the second image processing module 20.

The second image processing module 20 includes an arithmetic unit 21, which performs the thinning processes to the image data readout from the 2-port memory 30, a judgment unit 22, which judges whether or not a predetermined image-process under which the predetermined conditions are satisfied by the several thinning processes, is completed, and an unillustrated controller, which controls the entire module 1. The second image processing module 20 starts its operation in response to the first completion signal FIN 1, and outputs a second completion signal FIN2 when the thinning processes for an entire image data (the second image-process) are completed, and outputs a judgment signal RES showing an result whether or not the predetermined image-process under which the predetermined requirements are satisfied by the several thinning processes, is completed.

The 2-port memory 30 can be accessed from its two ports independently and concurrently by the first and the second image processing modules 10 and 20. The image data, which are obtained by the scanner and are defined in matrix, are stored in the 2-port memory 30, initially. The image data stored in the 2-port memory 30 are readout line by line, by the arithmetic units 11 and 21 of the first and the second image processing module 10 and 20 (hereinafter the readout image data by a line is called the line data). The 2-port memory 30 is, then, used as a work area for re-storing the data whenever the thinning process is performed. Finally, the image data that the image-process is completed are stored in the 2-port memory 30.

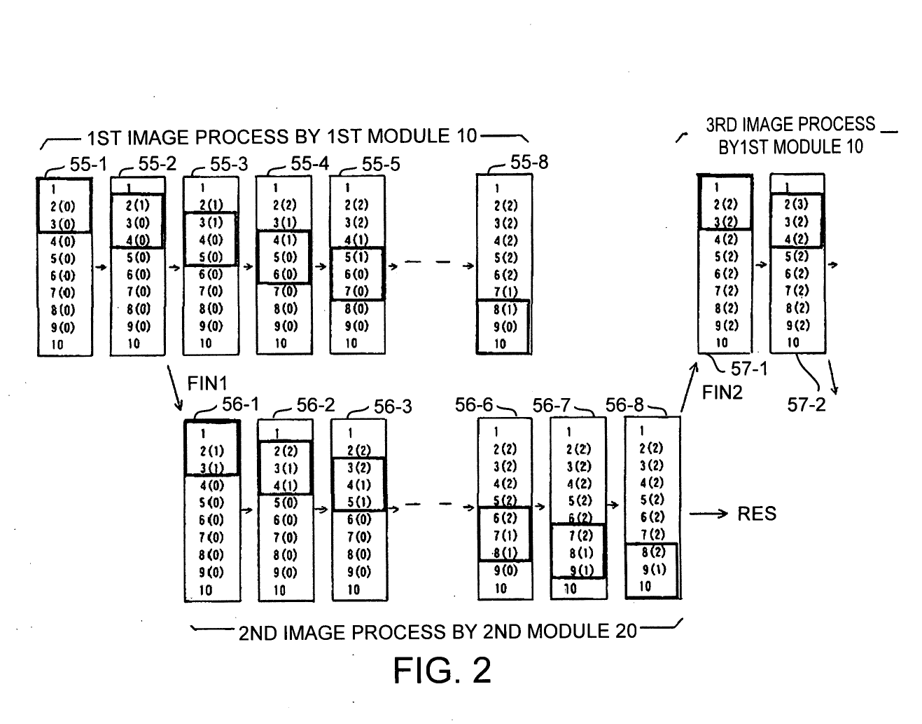

Next, the operation of the image-process performed in the image processing circuit illustrated in FIG. 1 is explained below with reference to FIG. 2. FIG. 2 is a conceptual view for explaining an operation of image-processes, each having a plurality of thinning processes, in the image processing circuit of FIG. 1. For the sake of the simplification of the explanation of the operation, the image data are made up with ten (10) line data in the first embodiment.

Before performing the thinning process, the image data 55-1 of the fingerprint obtained by the scanner are stored in the 2-port memory 30. As well as the description in the Background of the invention, the image data 55-1 are represented by two-value data in which a fingerprint ridge is represented by a white pixel and a fingerprint valley is represented by a black pixel wherein the black pixel has a certain level of a width. Therefore, in order to extract characteristics of a fingerprint from its image data, some black pixels are changed to white pixels for generating a single serial thin curve-line, which is made up with the black pixels under the thinning process.

In response to the activation signal STA applied from the controller, the first image-process is performed in the first image processing module 10. The first arithmetic unit 11 readouts the line data of a first through third lines, which are 1, 2(0) and 3(0) of the image data 55-1, from the 2-port memory 30. Then, the first arithmetic unit 11 performs the thinning process to the line data in the middle, which is the second line data 2(0), from the three line data. The result of the thinning process is restored in the second line, which is illustrated as the image data 55-2 in the 2-port memory 30, that is, the second line data are renewed by the thinning process while other two line data, which are the first and the third line data, are not renewed. Since the thinning process to the second line data is completed, the counter 12 is set at “2”.

Next, the first arithmetic unit 11 readouts the line data of the second through fourth lines, which are 2(1), 3(0) and 4(0) of the image data 55-2 from the 2-port memory 30. Then, the first arithmetic unit 11 performs the thinning process to the line data in the middle, which is the third line data 3(0), from the three line data. The result of the thinning process is restored in the second line, which is illustrated as the image data 55-3 in the 2-port memory 30, that is, the third line data are renewed by the thinning process while other two line data, which are the second and the fourth line data, are not renewed.

Since the thinning process to the third line data is completed, the counter 12 is set at “3”. When the counter 12 is set at “3”, the first complete signal FIN1 is outputted from the first image processing module 10 to the second image processing module 20 because the line data necessary to be processed in the second image processing module 20 are prepared. Simultaneously, the first arithmetic unit 11 continuously readouts the line data of the third through fifth lines, which are 3(1), 4(0) and 5(0) of the image data 55-3 from the 2-port memory 30 for the next thinning process to the fourth line data. The thinning processes to the unprocessed line data is continuously performed until the first image-process is completed.

On the other hand, in response to the first completion signal FIN1 outputted from the first image processing module 10, the second image-process by the second image processing module is performed. The second arithmetic unit 21 in the second image processing module 20 readouts the line data of the first through third lines, which are 1, 2(1) and 3(1) of the image data 56-1, from the 2-port memory 30. Then, the second arithmetic unit 21 performs the thinning process to the line data in the middle, which is the second line data 2(1), from the three line data. As shown in the FIG. 2, the first through third line data, which are 1, 2(1) and 3(1) of the image data 56-1, are the line data to which the first thinning process of the first image-process has been performed by the first arithmetic unit 11. Thus, the first thinning process of the second image-process is performed by the second arithmetic unit 21 in the second processing module 20 to the second line data using the first through third line data.

The result of the first thinning process of the second image-process is restored in the second line, which is illustrated as the image data 56-2 in the 2-port memory 30, that is, the second line data are renewed by the first thinning process of the second image-process while other two line data, which are the first and the third line data, are not renewed. Simultaneously, the result of the third thinning process of the first image-process as the first thinning process to the fourth line data, which was performed by the first arithmetic unit 11, is restored in the fourth line, which is illustrated as the image data 55-4 in the 2-port memory 30. The thinning processes to the unprocessed line data is continuously performed until the second image-process is completed.

As described above, the second arithmetic unit 21 in the second image processing module 20 performs the thinning process to line data, which has been processed by the first arithmetic unit 11 behind two lines. In other words, the fourth line data and the second line data, which are behind two lines, are processed in the first arithmetic unit 11 and the second arithmetic unit 21, respectively, at the same time, and the fifth line data and the third line data, which are behind two lines, are processed in the first arithmetic unit 11 and the second arithmetic unit 21, respectively, at the same time.

As described above, the operation of the first image processing module 10 is halted once when the thinning process to the ninth line data in the first image-process is completed. On the other hand, the second image processing module 20 continues its operation until the thinning process to the ninth line data of the second image-process is completed. When thinning process to the ninth line data of the second image-process performed by the second arithmetic unit 21 is completed, the judgment unit 22 in the second image processing module 20 is activated, and is outputs the judgment signal RES indicating the judgment result as to whether or not the predetermined image-process under which the predetermined conditions are satisfied by the several thinning processes, is completed When it is judged that the predetermined image-process is completed, the operations of the first and the second image processing modules 10 and 20 are terminated. If it is judged that the predetermined image-process is not completed, the second image processing module 20 outputs the second completion signal FIN2 to the first image processing module 10. The first image processing module 10 resumes its operation, which is the third image-process, in response to the second completion signal FIN2.

As described above, the image-process by the first image processing module 10 and the image-process by the second image processing module 20 are concurrently performed, although the line data to be processed by the second image processing module 20 is two lines behind from the line date to be processed by the first processing module 10. Then, it is judged whether or not the predetermined image-process under which the predetermined conditions are satisfied by the several thinning processes, is completed whenever the image-process by the second image processing module 20 is completed. When it is judged that the predetermined image-process is completed, the judgment signal RES indicating that the predetermined image-process is completed is outputted. Then, the operations of the first and the second image processing modules 10 and 20 are terminated.

According to the image processing circuit 100 of the first embodiment, the image processing circuit 100 includes the first image processing module 10, which performed (i)th image-process wherein (i) is an odd number, and the second image processing module 20, which performed (i+1)th image-process, wherein the line data to be processed by the second image processing module 20 is two lines behind from the line date to be processed by the first processing module 10. Further, the image-process by the first image processing module 10 and the image-process by the second image processing module 20 are concurrently performed. Thus, the process time can be reduced by half.

### The Second Embodiment

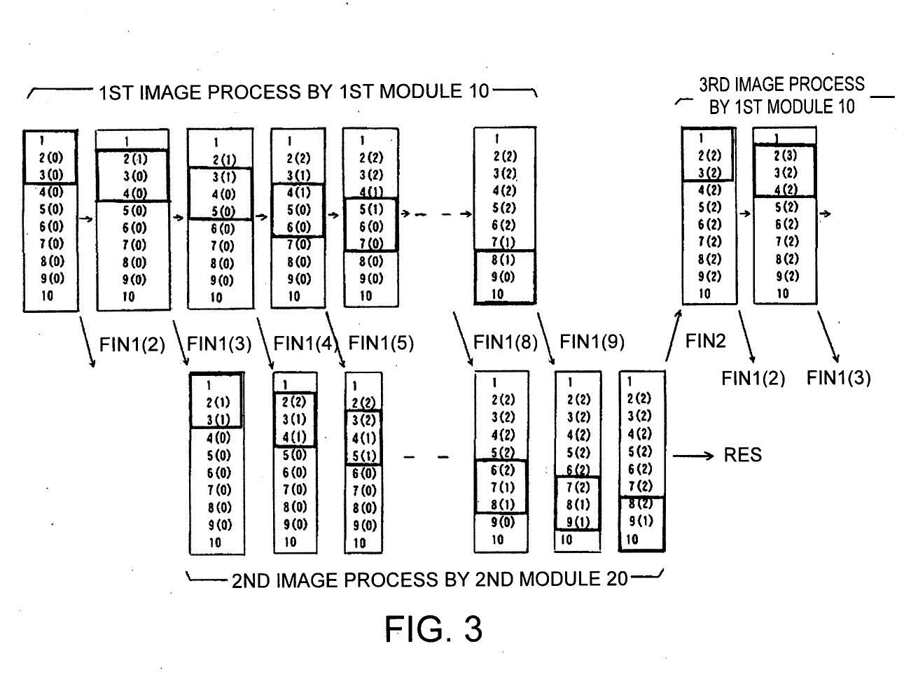

FIG. 3 is a conceptual view for explaining an operation of image-processes, each having a plurality of thinning processes, in an image processing circuit, according to a second embodiment. The operation of the image processing circuit, according to a second embodiment, is explained below with reference to FIG. 3.

The circuit structure of the image processing circuit of the second embodiment is the same as that of the image processing circuit 100 disclosed in FIG. 1. Thus, for the sake of brevity, the explanation of the circuit structure of the image processing circuit of the second embodiment is omitted.

As described in the first embodiment, the first image processing module 10 outputs the completion signal FIN1 to the second image processing module 20 only when the thinning process to the second line data is completed. However, according to the second embodiment, whenever the thinning process is completed to each line data, the first image processing module 10 outputs the line number processed, which is the number indicated by the counter 12, as the completion signal FIN1 to the second image processing module 20. On the other hand, in response to the line number indicated as the completion signal FIN1, which is transmitted from the first image processing module 10, the second image processing module 20 performs the process to the line data corresponding to the line number.

According to the image processing circuit 100 in the first embodiment, as for the processing time for each line data, it is set regardless of the contents of the line data to become same. However, according to the image processing circuit in the second embodiment, it is possible to employ circuits, which can change the processing time depending on the contents of the line data.

For example, when a particular circuit, which can shorten the processing time depending on the contents of the line data, such as a circuit that will not perform the thinning process to data in which white pixels are disposed intensively, is employed, the processing time can be further shortened.

### The Third Embodiment

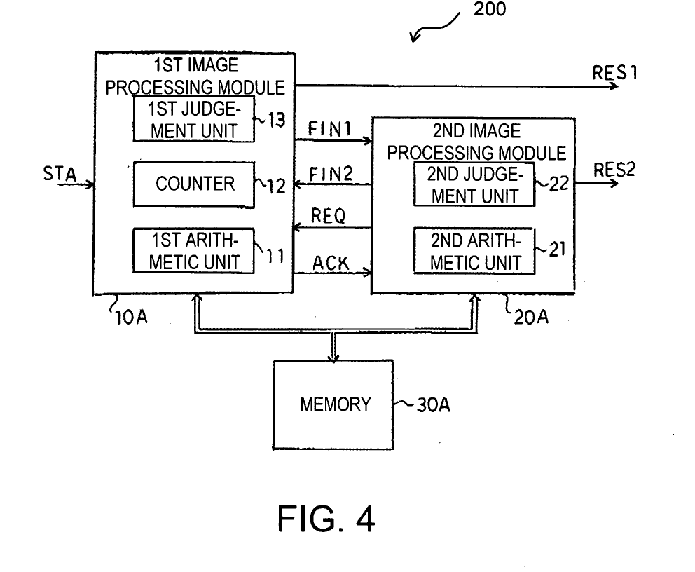

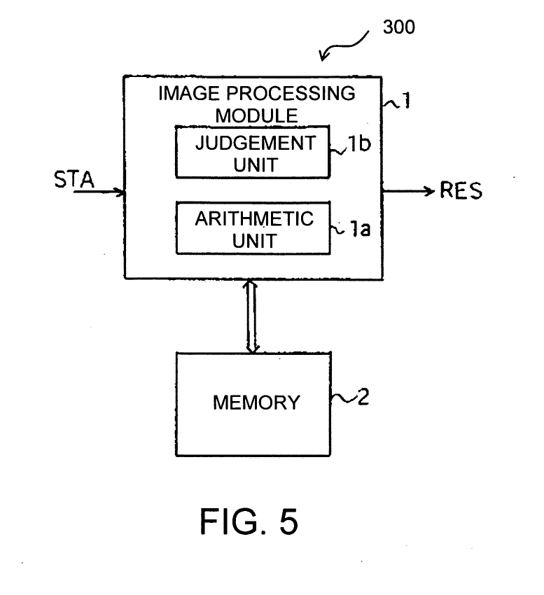

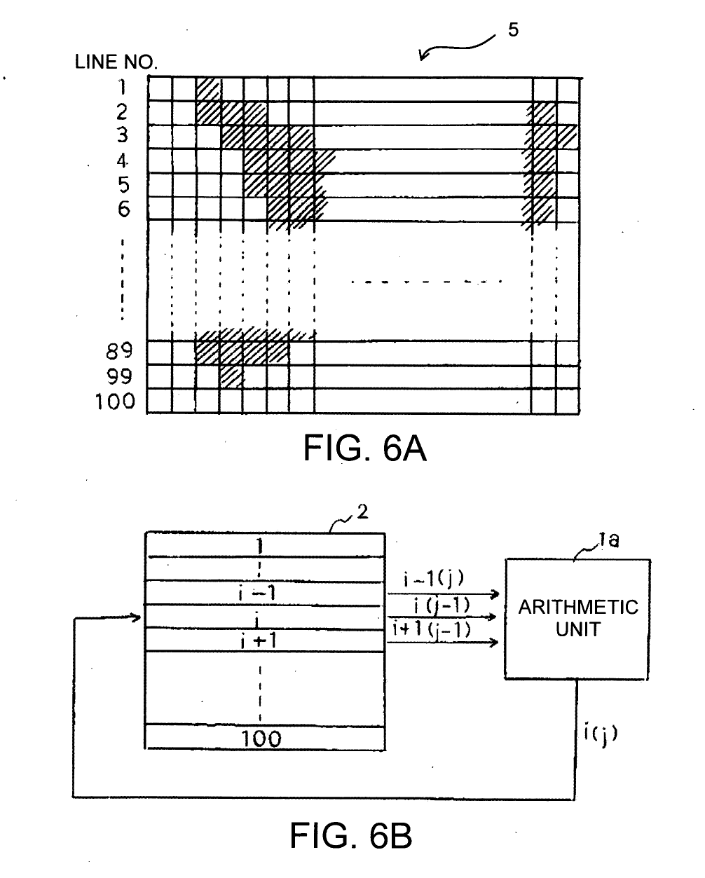

An image processing circuit 200 of the third embodiment is explained below with reference to FIG. 4, which is a circuit diagram of the image processing circuit 200. The image processing circuit 200 includes a first image processing module 10A, a second image processing module 20A and a memory 30A. The first image processing module 10A includes a first arithmetic unit 11, a counter 12, the first judgment unit 13 and an unillustrated controller. The first arithmetic unit 11 performs thinning processes to the image data, which are readout from the memory 30A. The counter 12 counts the number of times that the thinning processes to line data are performed. The judgment unit 13 judges whether or not a predetermined image-process under which the predetermined conditions are satisfied by the several thinning processes, is completed.

The first image processing module 10A states its operation in response to an activation signal STA applied from the controller, outputs a first completion signal FIN1 to the second image processing module 20A when the thinning processes to the predetermined line data of the image data are completed, and outputs a first judgment signal RES1 indicating the judgment result as to whether or not the predetermined image-process under which the predetermined requirements are satisfied by the several thinning processes, is completed after a first image-process is completed. Further, the first image processing module 10A resumes its operation for the next image-process in response to a second completion signal FIN2 outputted from the second image processing module 20A when the predetermined image-process is not completed yet.

Moreover, the first image processing module 10A outputs an allowance signal ACK for allowing the access to the memory 30A in response to a request signal REQ, which is outputted from the second image processing module 20A, for requesting the allowance to access the memory 30A from the second image processing module 20A.

The second image processing module 20A includes a second arithmetic unit 21, the second judgment unit 22 and an unillustrated controller. The first arithmetic unit 21 performs thinning processes to the image data, which are readout from the memory 30A. The second judgment unit 22 judges whether or not a predetermined image-process under which the predetermined conditions are satisfied by the several thinning processes, is completed. The second image processing module 20A starts its operation in response to the first completion signal FIN1, and outputs a second completion signal FIN2 when the thinning processes for the entire image data (the second image-process) are completed, and outputs a second judgment signal RES2 showing an result whether or not the predetermined image-process under which the predetermined requirements are satisfied by the several thinning processes, is completed.

Further, the second image processing module 20A outputs the request signal REQ for requesting the allowance to access the memory 30A from the second image processing module 20A to the first image processing module 10A when it is necessary to access the memory 30A in order to readout the image data stored therein. The second image processing module 20A can access the memory 30A when it receives the allowance signal ACK outputted from the first image processing module 10A.

The memory 30A used in the image processing circuit 200 of the third embodiment is a memory having a single port, which is connected a bus commonly connected to the first and the second image processing module 10A and 20A. The memory 30A initially stores the image data of the fingerprint, which is defined in matrix, and which is obtained by a scanner. The image data stored in the memory 30A are readout line by line, by the arithmetic units 11 and 21 of the first and the second image processing module 10A and 20A. The memory 30 is, then, used as a work area for re-storing the data whenever the thinning process is performed. Finally, the image data that the image-process is completed are stored in the memory 30A.

As well as the image processing circuit 100 of the first embodiment, the image processing circuit 200 includes the first image processing module 10A, which performed (i)th image-process wherein (i) is an odd number, and the second image processing module 20A, which performed (i+1)th image-process, wherein the line data to be processed by the second image processing module 20A is two lines behind from the line date to be processed by the first processing module 10A. However, the first image processing module 10A outputs the first judgment signal RES1 indicating the judgment result as to whether or not the predetermined image-process under which the predetermined requirements are satisfied by the several thinning processes, is completed when the (i)th image-process is completed.

Moreover, the first image processing module 10A outputs the allowance signal ACK in response to a request signal REQ, which is outputted from the second image processing module 20A if it does not access the memory 30A. After that, the allowance signal ACK is continuously outputted until the request signal REQ is halted so that the access to the memory 30A from the first image processing module is prohibited.

On the other hand, the second image processing module 20A outputs the request signal REQ to the first image processing module 10A when it is necessary to access the memory 30A. The second image processing module 20A can access the memory 30A when it receives the allowance signal ACK outputted from the first image processing module 10A. While the second image processing module 20A accesses the memory 30A, the request signal REQ is continuously outputted to the first image processing module. Then, when the access to the memory 30A is terminated, the second image processing module 20A stops outputting the request signal REQ.

According to the image processing circuit 200 of the third embodiment, since each of the first and the second image processing modules 20A and 30A includes the first and the second judgment unit 13 and 22, respectively, it is possible to detect the termination of the thinning operation, faster, in addition to the advantages obtained by the image processing circuit 100 of the first embodiment.

Further, according to the image processing circuit 200 of the third embodiment, the hand-shake access system is employed by using the request signal REQ and the allowance signal ACK to avoid the access competition occurred between the first and the second image processing modules 10A and 20A. Thus, it is not necessary to use the 2-port memory having a complicated circuit structure, which is used in the first and the second embodiments while the general memory 30A having a single port can be used for the image processing circuit 200 of the third embodiment.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

For example,

(a) although the image processing circuit of each embodiment is used for the thinning process of fingerprints, it can be used for the thinning process of other image data, such as data used in a character recognition system.

(b) As well as the image processing circuit in the second embodiment, whenever the thinning process is completed to each line data, the first image processing module 10A outputs the line number processed, which is the number indicated by the counter 12, as the completion signal FIN1 to the second image processing module 20A in the image processing circuit of the third embodiment.

(c) It is possible to have more than two image processing modules, which performs the thinning process concurrently. For example, the third image processing module is disposed between the first and the second image processing modules 10 and 20 in the first embodiment, the first completion signal is sent to the third image processing module and another completion signal is outputted to the second image processing module 20. The second completion signal FIN2 from the second image processing module 20 is sent to the first image processing module 10 as well without going through the third image processing module.

(d) Although three line data are used for the thinning process in each embodiment, a plurality of line data may be used for the thinning process in each embodiment. Moreover, although all line data are processed, every two or more line data may be processed. Further, although the line data are processed, rectangular or square block data having few pixels may be processed.

(e) Although the judgment condition made in the judgment units 11 and 21 is set to that the predetermined image-process is completed, the judgment condition can be set to any condition. For example, the judgment condition may be the number of the thinning process to the certain line data to be repeated.

Various other modifications of the illustrated embodiment will be apparent to those skilled in the art on reference to this description. Therefore, the appended claims are intended to cover any such modifications or embodiments as fall within the true scope of the invention.

What I claim is:

1. An image processing circuit, comprising:
a memory storing an image data, which includes a plurality of line data disposed regularly;
a first image processing module including a first arithmetic unit and a counter, the first arithmetic unit performing an image-process, which includes a plurality of thinning processes, at each of which a plurality of line data are readout from the memory, and at each of which one line data is processed by using the line data readout by the first image processing module, and the counter counting a number of times that the thinning processes are performed, wherein the processed line data is restored in the memory, and wherein the first image processing module outputs a first completion signal after the thinning processes for a certain times are completed; and
a second image processing module, which start its operation in response to the first completion signal, including a second arithmetic unit and a judgment unit, the second arithmetic unit performing an image-process, which includes a plurality of thinning processes, at each of which a plurality of line data, which are partially or totally processed by the first image processing module, are readout from the memory, and at each of which one line data is processed by using the line data readout by the second image processing module, wherein the processed line data is restored in the memory, and wherein the second image processing module outputs a second completion signal after the thinning processes for the entire image data stored in the memory are completed, and outputs the judgment signals indicating that a predetermined image-process under which a predetermined requirement is satisfied is completed, based on a judgment result made by the judgment unit.

2. An image processing circuit as claimed in claim 1, wherein the memory is a two-port memory, whereby the first and the second image processing modules independently and concurrently access the two-port memory.

3. An image processing circuit as claimed in claim 1, wherein the readout line data is three lines of the line data, which are disposed sequentially, and the thinning process is performed to the middle of the line data.

4. An image processing circuit, comprising:
a memory storing an image data, which includes a plurality of line data disposed regularly;
a first image processing module including a first arithmetic unit and a counter, the first arithmetic unit performing an image-process, which includes a plurality of thinning processes, at each of which a plurality of line data are readout from the memory, and at each of which one line data is processed by using the line data readout by the first image processing module, and the counter counting a number of times that the thinning processes are performed, wherein the processed line data is restored in the memory, and wherein the first image processing module outputs a first completion signal whenever the thinning process is completed,
a second image processing module, which start its operation in response to the first completion signal, including a second arithmetic unit and a judgment unit, the second arithmetic unit performing an image-process, which includes a plurality of thinning processes, at each of which a plurality of line data, which are partially or totally processed by the first image processing module, are readout from the memory, and at each of which one line data is processed by using the line data readout by the second image processing module, wherein the processed line data is restored in the memory, and wherein the second image processing module outputs a second completion signal after the thinning processes for an entire image data stored in the memory are completed, and outputs the judgment signals indicating that a predetermined image-process under which a predetermined requirement is satisfied is completed, based on a judgment result made by the judgment unit.

5. An image processing circuit as claimed in claim 4, wherein the memory is a two-port memory, whereby the first and the second image processing modules independently and concurrently access the two-port memory.

6. An image processing circuit as claimed in claim 4, wherein the readout line data is three lines of the line data, which are disposed sequentially, and the thinning process is performed to the middle of the line data.

7. An image processing circuit, comprising:
a memory storing an image data, which includes a plurality of line data disposed regularly;
a first image processing module including a first arithmetic unit, a counter and the first judgment unit, the first arithmetic unit performing an image-process, which includes a plurality of thinning processes, at each of which a plurality of line data are readout from the memory, and at each of which one line data is processed by using the line data readout by the first image processing module, the counter counting a number of times that the thinning processes are performed, wherein the processed line data is restored in the memory, and the first judgment unit judging whether or not a predetermined image-process under which a predetermined requirement is satisfied is completed after the thinning processes are performed to the entire image data stored in the memory, and wherein the first image processing module outputs a first completion signal after the thinning processes for a certain times are completed; and
a second image processing module, which start its operation in response to the first completion signal, including a second arithmetic unit and a second judgment unit, the second arithmetic unit performing an image-process, which includes a plurality of thinning processes, at each of which a plurality of line data, which are partially or totally processed by the first image processing module, are readout from the memory, and at each of which one line data is processed by using the line data readout by the second image processing module, wherein the processed line data is restored in the memory, wherein the second image processing module outputs a second completion signal after the thinning processes for an entire image data stored in the memory are completed, and outputs the judgment signals indicating that a predetermined image-process under which the predetermined requirements are satisfied is completed, based on a judgment result made by the second judgment unit, and wherein the second image processing module outputs a request signal for obtaining an allowance to access the memory, and accesses the memory in response to an allowance signal outputted from the first image processing module at the time that the first image processing module does not access the memory.

8. An image processing circuit as claimed in claim 7, wherein the memory is a single-port memory.

9. An image processing circuit as claimed in claim 7, wherein the readout line data is three lines of the line data, which are disposed sequentially, and the thinning process is performed to the middle of the line data.
